(19) United States
(12) Patent Application Publication
(10) Pub. No.: US 2014/0181200 A1
(43) Pub. Date: Jun. 26, 2014

(54) ONE GROUP PAGING SCHEME FOR MACHINE-TO-MACHINE COMMUNICATION

(71) Applicant: INTEL CORPORATION, Santa Clara, CA (US)

(72) Inventors: Rui Huang, Beijing (CN); Honggang Li, Beijing (CN); Shantidev Mohanty, Santa Clara, CA (US)

(21) Appl. No.: 13/994,798

(22) PCT Filed: Dec. 30, 2011
(86) PCT No.: PCT/CN2011/084967

§ 371 Date: Mar. 11, 2014

(51) Int. Cl. H04W 4/00; H04W 68/02

(52) U.S. Cl. CPC H04W 4/005; H04W 68/02
USPC 709/204

(57) ABSTRACT

A group paging method is disclosed for efficient machine-to-machine communication in a wireless network. The group paging method enables M2M-capable base stations to group M2M-capable mobile stations according to their traffic properties, assign them a group paging ID, and thereafter page the M2M device, whether the mobile station is asleep or not, by way of a paging channel. The group paging method mitigates traffic congestion on the wireless network.

### TECHNICAL FIELD

This application relates to machine-to-machine communication in some advance wireless systems, such as IEEE 802.16 and 3GPP.

### BACKGROUND

Machine-to-machine communication is a very distinct capability that enables the implementation of the “Internet of things”. Machine-to-machine communication is defined as an information exchange between a subscriber station and a server station in a core network (through a base station) or between subscriber stations, which may be carried out without any human interaction. Its basic architecture proposed in IEEE 802.16m is given below in FIG. 1.

Several industry reports have scoped out the huge potential for this market, with millions of devices being connected over the next five years and revenues in excess of $300 billion (Harbor Research, 2009). So, machine-to-machine technology is a hot research item in some dominated wireless standard research groups, i.e., 3GPP and 802.16.

According to one IEEE 802.16p system requirement, a machine-to-machine system shall support a large number of devices and mechanisms for low power consumption in machine-to-machine devices. Therefore, there are expected to be a large number of machine-to-machine devices in the domain of the machine-to-machine base station. The machine-to-machine support thus is expected to require a huge amount of interactions between the machine-to-machine devices and their supporting base station. For instance, where the base station needs to communicate with the separated machine-to-machine devices, one by one, this would result in some network congestion.

Thus, there is a continuing need for a machine-to-machine solution that overcomes the shortcomings of the prior art.

### BRIEF DESCRIPTION OF THE DRAWINGS

The foregoing aspects and many of the attendant advantages of this document will become more readily appreciated as the same becomes better understood by reference to the following detailed description, when taken in conjunction with the accompanying drawings, wherein like reference numerals refer to like parts throughout the various views, unless otherwise specified.

FIG. 1 is a simplified block diagram of a wireless network supporting a M2M group-based paging method, according to some embodiments;

FIG. 2 is a block diagram of a basic architecture for M2M communication proposed in the IEEE 802.16m specification, according to some embodiments;

FIG. 3 is a hypothetical wireless network consisting of a M2M-capable and non-M2M-capable mobile stations (e.g. smart meters) in which the M2M group-based paging method of FIG. 1 is used, according to some embodiments;

FIG. 4 is a timing diagram showing operations between an M2M-capable base station and an M2M-capable mobile station, where the base station employs the M2M group-based paging method of FIG. 1, according to some embodiments;

FIG. 5 is a flow diagram showing the operations of the M2M group-based paging method of FIG. 1, according to some embodiments; and

FIG. 6 is a simplified block diagram showing some features of the M2M-capable base station and M2M-capable mobile station that perform the group-based paging method of FIG. 1, according to some embodiments.

### DETAILED DESCRIPTION

In accordance with the embodiments described herein, a group paging method is disclosed for efficient machine-to-machine communication in a wireless network. The group paging method enables M2M-capable base stations to group M2M-capable mobile stations according to their traffic properties, assign them a group paging ID, and thereafter page the M2M device, by way of a paging channel. The group paging method mitigates traffic congestion on the wireless network.

In the following detailed description, reference is made to the accompanying drawings, which show by way of illustration specific embodiments in which the subject matter described herein may be practiced. However, it is to be understood that other embodiments will become apparent to those of ordinary skill in the art upon reading this disclosure. The following detailed description is, therefore, not to be construed in a limiting sense, as the scope of the subject matter is defined by the claims.

The background section describes the potential impact from machine-to-machine services. Machine-to-machine (M2M) services are distinct from human interaction services (e.g., laptop and cellular phone use) in several respects. For example, M2M transmissions generally involve small quantities of data being transmitted. The M2M transmissions may be infrequent, relative to human transmissions. The M2M transmissions tend to be location-specific. The M2M devices tend to have a lower mobility, relative to highly mobile human interaction devices. And, the M2M transmissions may be time-controlled, that is, the data may be transmitted in a predefined interval, in short, these features enable the optimization of the existing human interaction services protocol, which is focused on making dedicated subscriber communication possible.

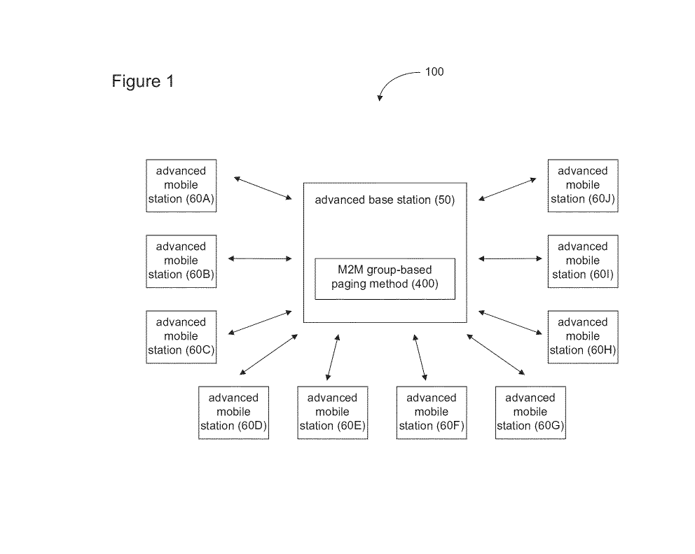

FIG. 1 is a simplified block diagram of a wireless network 100 with an advanced base station 50 that includes an M2M group-based paging method 400, according to some embodiments. In addition to the advanced base station 50, the wireless network 100 includes several advanced mobile stations (AMSs) 60A, 60B, . . . , 60J (hereafter, “AMSs 60). The AMSs may be sensors or meters, for example, that are designed with minimum capability to report data, although the types of data that may be reported is quite extensive. Examples of data that may be received from these AMSs include temperature or voltage information, optical data, chemical composition, and so on.

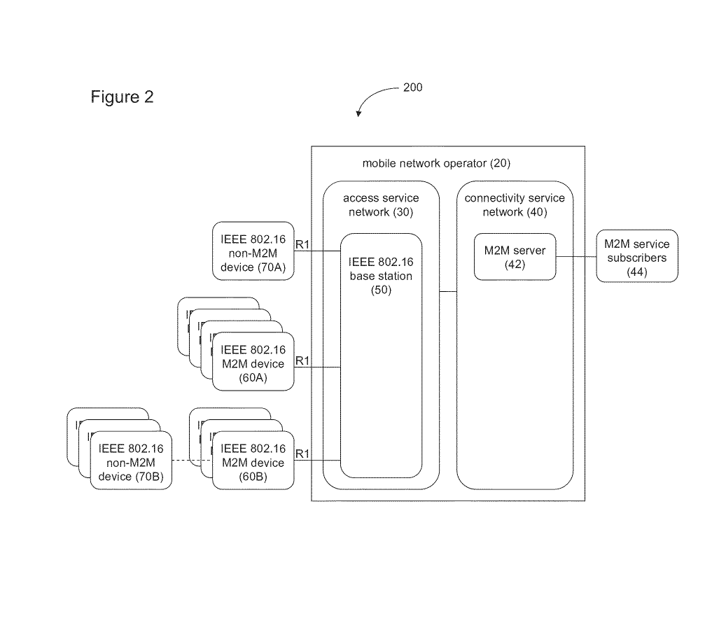

The basic architecture for M2M communication is proposed in the IEEE 802.16m specification, and is depicted in FIG. 2, according to some embodiments. A system 200 consists of a mobile network operator 20 and several mobile devices, denoted as IEEE 802.16 M2M devices 60A, 60B, . . . (collectively M2M devices 60 or M2M mobile stations 60) and IEEE 802.16 non-M2M devices 70A, 70B . . . (collectively, non-M2M devices 70 or non-M2M mobile stations 70). The mobile network operator 20 features an access service network 30 and a connectivity service network 40. An IEEE 802.16 base station 50 in the access service network 30 is connected to several of the M2M base stations 60 and non-M2M base stations 70. An M2M server 40 in the connectivity service network 40 is connected to M2M service subscribers 44.

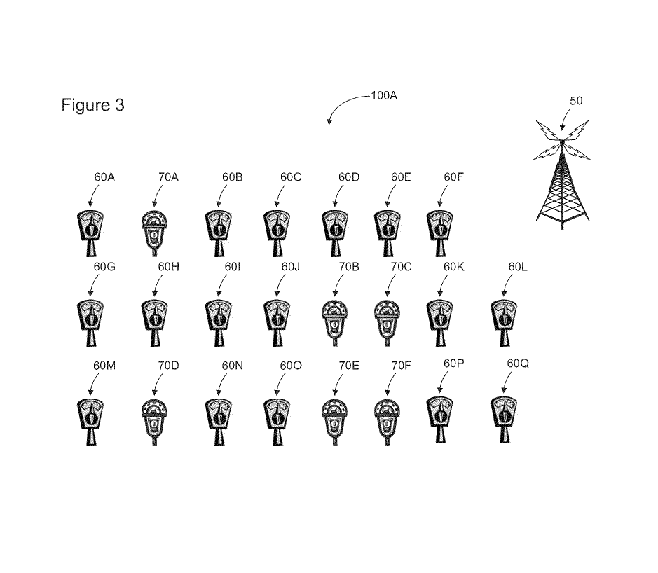

One efficient method to optimize the machine-to-machine network is aggregation paging for multiple M2M devices, defined herein as “M2M group-based paging”. FIG. 3 presents a hypothetical wireless network 100A consisting of a parking lot with two different types of meters. Meters 60A-60Q are M2M-capable advanced mobile devices (collectively, AMSs 60) while meters 70A-70F are not M2M-capable advanced mobile devices (collectively, AMSs 70). Suppose, for example, that the meters simply report whether a car is parked at their station. The base station 50 services both types of sensors, the AMSs 60 and the AMSs 70. Where it supports the group-based paging method 400, the base station 50 will be able to communicate with the AMSs 60 over a paging channel, using a technique described below. Communication with the legacy AMSs 70 will take place on a device-by-device basis. In other words, the base station 50 will be limited to individually communicating with the legacy AMSs 70.

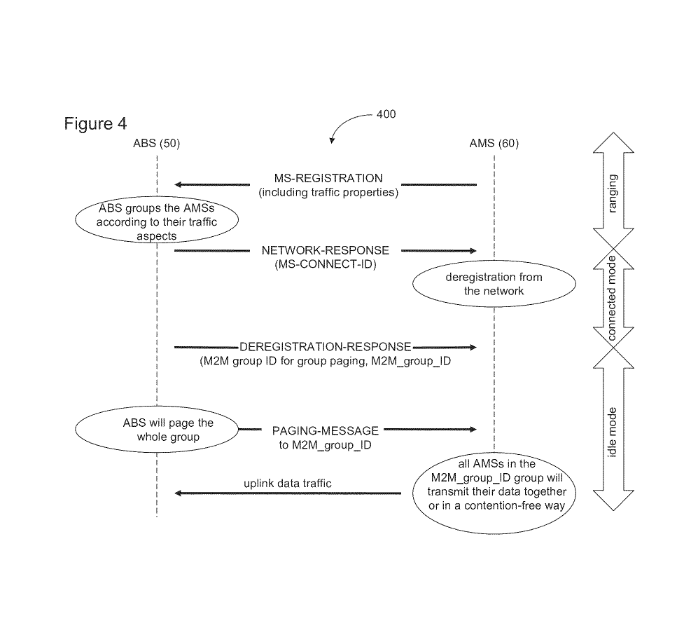

FIG. 4 shows the M2M group-based paging method 400 as a series of back-and-forth operations between an advanced base station (ABS) 50 and an advanced mobile station (AMS) 60, according to some embodiments, where the latter is presumably one of several additional AMSs in a wireless network, such as the wireless network 100A (FIG. 3). The mechanism shown in FIG. 4 may be valid in other wireless systems, such as 3GPP, with some term modifications. The operations of the M2M group-based paging method 400 commence with the AMS 60 attempting to enter the wireless network.

The M2M group-based paging method 400 features two vertical lines, one denoting the ABS 50 and the other denoting the AMS 60. As used herein, the ABS and AMS are defined as entities having capability under the IEEE 802.16m specification, with mobile stations being further divided into M2M-capable (60) and non-M2M-capable (70) devices. The arrows at the right side of FIG. 2 describes characteristics of the AMS 60, which is either ranging (that is, trying to find an ABS to be its serving base station), in a connected mode (connection with the ABS has been established), or in an idle mode (connected to the wireless network, but not presently communicating with the ABS).

The group-based paging method 400 commences with the AMS 60 entering or reentering the network. Initially, the AMS 60 will inform the ABS 50 about its traffic properties (e.g., the location, transmission duration, and action time), with these traffic properties being included in a request to register on the wireless network, denoted as MS REGISTRATION (the 802.16m request is known as AAI-REG-REQ). In some embodiments, the traffic properties are used by the ABS 50 as grouping factors, used to decide which AMSs to group together for subsequent paging operations.

In reply to the MS REGISTRATION request made by the AMS 60, the ABS 50 feeds back a connection identifier, denoted MS-CONNECT-ID, to the AMS, denoted NETWORK-RESPONSE (the 802.16m connection identifier is known as CID and the response is known as AAI-REQ-RSP). Once it has its own unique MS-CONNECT-ID, the AMS 60 may communicate with the ABS 50, and may forward its data to ABS as a registered member of the wireless network. As shown by the arrows on the right, since connection to the network has been established, the AMS 60 is now in a connected mode.

When not performing any data transmissions, to save power, the AMS 60 may enter an idle state, or a sleep mode. While in the idle mode or sleep mode, the AMS 60 is nevertheless able to listen to a paging channel. In some embodiments, the AMS 60 checks the paging channel periodically, while in sleep mode, so as to be apprised of any multicast transmissions from the ABS 50.

Upon obtaining relevant information of multiple machine-to-machine devices located in its cell, the ABS 50 bundles the M2M AMSs 60 together, so to speak, and assigns a unique M2M_group_ID to the bundled group. The identified AMSs to which the M2M_group_ID is assigned share similar traffic properties, such as having a similar transmission interval, for example, The ABS 50 informs each M2M AMS 60 in this identified group of its M2M_group_ID in the deregistration signaling, denoted DEREGISTRATION-RESPONSE (the 802.16m response is known as AAI-DEG-RSP), The M2M_group_ID is multicast by the ABS 50 in the DEREGISTRATION-RESPONSE. Once it is deregistered from the network, the M2M AMS 60 will enter into an idle mode. This is desired, for example, in order to save power.

From this point, all AMSs 60 having this M2M_group_ID may be paged by a single paging message, denoted PAGING-MESSAGE (the 802.16m message is known as AAI-PAG-ADV) in FIG. 4. The ability to page several M2M devices simultaneously reduces the paging overhead and network congestion on the wireless network, in some embodiments. In some embodiments, AMSs 60 that are paged by the aggregated paging may forward their data, using either aggregation or separation, to the ABS 50. If aggregation is used, the data for the individual AMSs 60 are transmitted together. If separation is used, the data for the individual AMSs 60 are transmitted separately.

Once the ABS 50 pages the entire group of ABSs 60 sharing the M2M_group_ID, the AMSs will transmit their data together or in a contention-free way, in some embodiments. This means that the ABS 50 has scheduled the individual M2M devices when paging them, such that the M2M devices in this group need not request contested resources.

In the prior art, to achieve the results illustrated in FIG. 4, multiple paging messages would have to be sent by the ABS 50 to each AMS in the wireless network. This group-based paging approach reduces the paging channel overload greatly fix the machine-to-machine network. In current specifications and protocols, there exists only one-to-one paging, in which the page includes the specific mobile station's MAC address. By assigning a group ID to the AMSs having common traffic properties, the ABS is able to page multiple AMSs in the wireless network simultaneously.

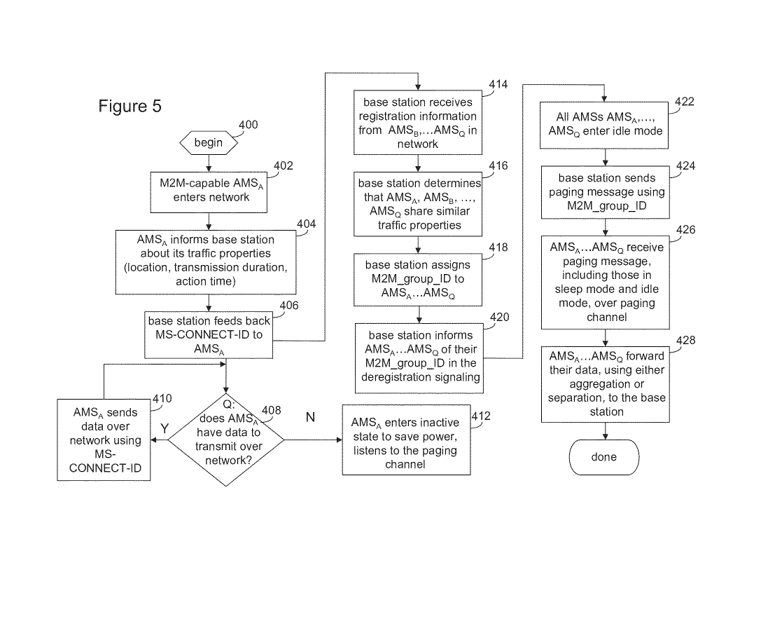

FIG. 5 is a flow diagram depicting the operations of FIG. 4, according to some embodiments. The operations of FIG. 5 are assumed to be part of a wireless network, such as the wireless network 100A of FIG. 3, with an M2M-capable ABS 50 and M2M-capable AMSs 60A-60Q, as well as non-M2M-capable AMSs 70A-70F. Of the M2M-capable AMSs 60, a single AMS 60, denoted AMS_{A}, is entering the wireless network 100A. (Where they constitute stationary sensors or meters, as in FIG. 3, the AMSs 60 may not actually “enter” the network. Nevertheless, the operations of FIG. 5 are performed at the outset for each AMS wanting to register with the network.)

First, the M2M-capable AMS_{A} enters the network 100A (block 402). The AMS_{A} informs the ABS 50 about its traffic properties, including, but not limited to, location, transmission duration, and action time (block 404). Upon receiving the request to enter the network (MS-REGISTRATION), the ABS 50 feeds a unique identifier (MS-CONNECT-ID) to the AMS_{A} (block 406). Where it has data to send over the network 100A (block 408), the AMS_{A} transmits using the MS-CONNECT-ID (block 410). Otherwise, the AMS_{A} enters a sleep mode (block 412). In some embodiments, the AMS_{A} continues to periodically listen to the paging channel while in sleep mode.

Meanwhile, the ABS 50 may receive registration information from the other AMSs on the wireless network 100A, denoted AMS_{B}, . . . , AMS_{Q} (block 414). Where it determines that these additional AMSs share similar traffic properties (block 416), the ABS 50 assigns a new group identifier, denoted M2M_group_ID, to AMS_{A}, AMS_{B}, . . . , AMS_{Q} (block 418). The ABS 50 informs AMS_{A}, . . . , AMS_{Q} of their new group identifier in the deregistration signaling (block 420). In some embodiments, the DEREGISTRATION_RESPONSE message is multicast to all AMSs sharing the M2M_GROUP_ID, where they are not transmitting or receiving, the AMSs AMS_{A}, . . . , AMS_{Q} enter an idle mode (block 422).

Thereafter, the ABS 50 is able to communicate with the AMSs AMS_{A}, . . . , AMS_{Q} over a paging channel. The ABS 50 sends the paging message using the M2M_group_ID (block 424). The AMS_{A}, . . . , AMS_{Q}, including those AMSs in either sleep mode or idle mode, will receiving paging messages over the paging channel from the ABS 50 (block 426). Finally, the AMS_{A}, . . . , AMS_{Q} are able to forward their data, using either aggregation or separation, to the ABS 50 (block 428).

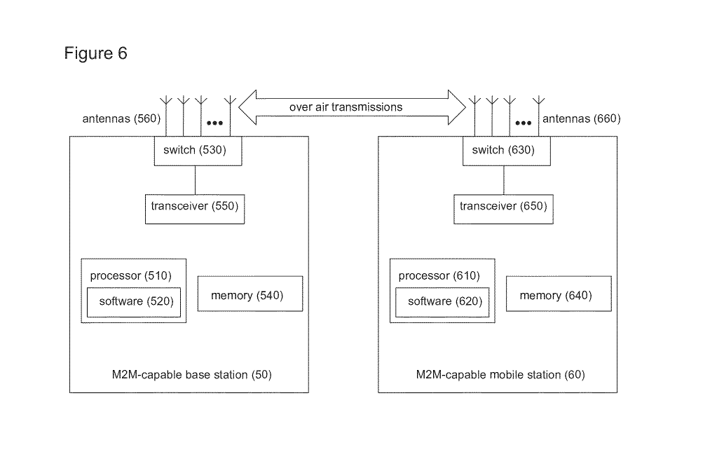

FIG. 6 is a simplified block diagram of the M2M-capable ABS 50 and M2M-capable AMS 60, according to some embodiments. Both the ABS 50 and AMS 60 include additional circuitry that is not shown in FIG. 6, but they do share many common features. Both include one or more antennas 560, 660, for receiving incoming over-the-air transmissions, and a transceiver 550, 650, for processing the incoming signal. Both include some processor 510, 610, and software 520, 620 being executed by the processor, as well as some memory 540, 640. The operations of FIGS. 4 and 5 may be implemented using software, firmware, hardware, or a combination of these. In some embodiments, the operations of FIGS. 4 and 5 are implemented, in part, using software 520, 620.

While the application has been described with respect to a limited number of embodiments, those skilled in the art will appreciate numerous modifications and variations therefrom. It is intended that the appended claims cover all such modifications and variations as fall within the true spirit and scope of the invention.

We claim:

1. A method for communicating over a wireless network between a base station and a plurality of machine-to-machine-capable mobile stations, the method comprising:
receiving, by the base station, a request to register on the wireless network from a first mobile station of the plurality of machine-to-machine-capable mobile stations, wherein the request to register includes a first traffic property;
assigning, by the base station, a connection identifier to the first mobile station;
receiving, by the base station, a second request to register on the wireless network from a second mobile station of the plurality of machine-to-machine-capable mobile stations, wherein the second request to register includes a second traffic property;
assigning, by the base station, a group identifier to the first mobile station and the second mobile station, wherein the assignment is based on the first traffic property and the second traffic property; and
sending, by the base station, a paging message to the first mobile station and the second mobile station using the group identifier.

2. The method of claim 1, further comprising:
determining, by the base station, that the first traffic property and the second traffic property are identical.

3. The method of claim 2, further comprising:
receiving, by the base station, the traffic property along with the request to register from the first mobile station;
wherein the traffic property comprises location info abort about the first mobile station.

4. The method of claim 2, further comprising:
receiving, by the base station, the traffic property along with the request to register from the first mobile station;
wherein the traffic property comprises transmission duration information about the first mobile station.

5. The method of claim 2, further comprising:
receiving, by the base station, the traffic property along with the request to register from the first mobile station;
wherein the traffic property comprises action time about the first mobile station.

6. The method of claim 1, communicating, by the base station, with the mobile station and the second mobile station using the group identifier further comprising:
communicating, by the base station, with the first mobile station immediately; and
communicating, by the base station, with the second mobile station after a time delay;
wherein the first mobile station is in an active state or inactive state and the second mobile station is in an active state or inactive state.

7. The method of claim 1, further comprising:
broadcasting, by the base station, over a paging channel or other broadcast channel using the group identifier;
wherein only the first mobile station and the second mobile station will receive the transmission.

8. The method of claim 2, further comprising:
receiving, by the base station, a third request to register on the wireless network from a third mobile station of the plurality of mobile stations, wherein the third request to register includes third a traffic property; and
not communicating, by the base station, the group identifier to the third base station because the third traffic property is not identical to the first traffic property.

9. The method of claim 1, further comprising:
receiving, by the base station, data from the first mobile station and the second mobile station using an aggregated scheduling resource.

10. The method of claim 5, further comprising:
receiving, by the base station, data from the third mobile station using a separated scheduling resource.

11. A machine-to-machine-capable mobile station, comprising:
one or more antennas to transmit a signal and to receive a second signal in a wireless network;
a transceiver to convert received signals to digital form and convert signals to be transmitted to analog form; and
software being executed by a processor, the software to process the received signals and the signals to be transmitted, the software further to:
transmit a request to register on the wireless network to a base station on the wireless network, wherein the request to register includes a traffic property;
receive a connection identifier from the base station;
receive a group identifier from the base station, wherein the group identifier is also received by other mobile stations in the wireless network having the traffic property; and
receive a paging message using the group identifier.

12. The machine-to-machine-capable mobile station of claim 11, the software to further:
put the mobile station into an idle mode;
wherein the mobile station listens to a paging channel to receive the paging message while in the idle mode.

13. The machine-to-machine-capable mobile station of claim 11, the software to further:
enter into a sleep mode;
wherein the mobile station listens to a paging channel to receive the paging message while in the sleep mode.

14. The machine-to-machine-capable mobile station of claim 11, the software to further:
receive a broadcast from the base station over the paging channel, wherein the broadcast uses the group identifier.

15. The machine-to-machine-capable mobile station of claim 11, the software to further:
send data to the base station using aggregation.

16. The machine-to-machine-capable mobile station of claim 11, the software to further:
send data to the base station using separated scheduling resource.

17. An article comprising a medium containing programming instructions which, when executed by a processor, cause the processor to perform the following steps:
receive, by a base station, in a wireless network, a request to register on the wireless network from a first mobile station, the first mobile station and the base station being machine-to-machine-capable devices, wherein the request to register includes a traffic property;
assign, by the base station, a connection identifier to the first mobile station;
receive, by the base station, a second request to register on the wireless network from a second mobile station, the second mobile station being a machine-to-machine-capable device, wherein the second request to register includes the traffic property;
receive, by the base station, a third request to register on the wireless network from a third mobile station, the third mobile station being a non-machine-to-machine-capable device, wherein the third request to register includes the traffic property;
assign, by the base station, a group identifier to the first mobile station and the second mobile station, wherein the assignment is based on the traffic property; and
send, by the base station, a paging message to the first mobile station and the second mobile station using the group identifier;
wherein the paging message is not received by the third base station.

18. The article of claim 17, further causing the processor to perform the following steps:
receive, by the base station, data from the first mobile station and the second mobile station using an aggregated scheduling resource.

19. The article of claim 17, further causing the processor to perform the following steps:
receive, by the base station, data from the third mobile station using a separated scheduling resource.

20. The article of claim 17, further causing the processor to perform the following steps:
receive, by the base station, the traffic information from a plurality of machine-to-machine-capable mobile stations; and
send, by the base station, the paging message to the plurality of machine-to-machine-capable mobile stations, using the group identifier;
wherein the traffic information is selected from a group consisting of location, transmission duration, and action time.
